(19) United States
(12) Patent Application Publication
(10) Pub. No.: US 2024/0085860 A1
(43) Pub. Date: Mar. 14, 2024

(54) Innovative device to remind of international and internal events.

(71) Applicant: Budur Jibril Ibrahim, Jeddah (SA)

(72) Inventor: Budur Jibril Ibrahim, Jeddah (SA)

(21) Appl. No.: 17/941,563

(22) Filed: Sep. 9, 2022

(51) Int. Cl. G04G 21/02; A01M 29/18; G01K 13/20; G04G 9/00

(52) U.S. Cl. CPC G04G 21/025; A01M 29/18; G01K 13/223; G04G 9/0064

(57) ABSTRACT

A device for displaying time and date in the form of a wall clock that has several features in one clock, it contains a smart electronic calendar with a list of all international and internal days or events for each country, through synchronization with Hijri (AH) and Gregorian (AD) calendar to display the international events such as Mother's Day, internal events when determining the country in its National Day or any national events to be displayed, the ability to specify any date and name the event to be reminded, such as someone's birthday, the clock has several features: an infrared, gas and smoke sensor MQ-2 and slots that emit ultrasound to repel insects, this clock provides a seamless experience to get the alerts and important information that the user needs on a daily basis, in addition to several security features that will be mentioned in the detailed description.

### CROSS REFERENCE TO RELATED APPLICATIONS

The following documents are about some of the previous technologies in the same field:

U.S. Pat. No. 4,681,460-A

Filed Date: 1986 Sep. 12

Disclosed a world time watch comprising the time of the place corresponding to the time difference displayed in the time zone, wherein the numbers of the place list include marks for indicating the shifting of time in accordance with the daylight saving time.

U.S. Pat. No. 4,887,251-A

Filed Date: 1988 Mar. 18

Disclosed a world timepiece which gives information about time or date of the areas in different time zones includes an input keyboard for inputting area code information corresponding to an area for the time or date of which is required, a code memory for storing the inputted area code information.

U.S. Pat. No. 7,359,288-B2

Filed Date: 2003 Mar. 21

Disclosed a method and apparatus for automatically displaying the correct time and date when initially activating the clock, the clock is plugged into a power grid then the correct time and date are displayed without the need to set the clock.

U.S. Pat. No. 8,644,782-B2

Filed Date: 2012 Mar. 30

Disclosed a method and apparatus for changing a frequency of a clock signal to avoid interference, changing a frequency of the first clock signal from the first frequency to the second frequency responsive to determining that signals are to be conveyed on a second interface at a third frequency.

U.S. Ser. No. 10/365,875-B2

Filed Date: 2018 Aug. 9

Disclosed an electronic device for changing the clock, includes housing, display panel, a clock generator and a first processor, which may communicate with an external device such as a Smartphone or a wearable device.

### THE BACKGROUND OF THE INVENTION

### 1. The Field of the Invention

The present invention relates generally to the field of clocks and in particular to the field of wall clocks, that has several features in one clock with a display of time and date, security features and smart electronic calendar with a list of all international and internal days or events for each country, in addition to some sensors that have a security feature.

### 2. Description of the Related Technical Field

Wall clocks that contain date and time display are known specifically, and there are many smart electronic wall clocks that contain several features such as: Display time, date, temperature, humidity, alarm, distance reading, fitness progress notification, traffic or taxi arrival, the notification of Uber, and home compatibility to view indoor conditions such as when the light turns on or the door is open and other features.

As for the calendar in general it takes many forms, paper as it is usually known or electronic integrated with the clock in the mobile phone or any apparatus that is characterized by the feature of displaying time and date.

The features of the devices currently available in the field of wall clocks are few and do not include the necessary functional properties, and it does not contain a reminder list of the international events and synchronize Hijri (AH) and Gregorian (AD) calendar, and it does not work under harsh weather conditions and withstand humidity, high temperatures and extreme cold.

Current wall clocks do not support the technology of some important sensors which are: Infrared (forehead thermometers), smoke and toxic gas detection sensors, insect repelling by ultrasound slots, while this innovative wall clock solves these problems as it contains several features in one clock and it's not limited to the feature of displaying time or some notifications and alerts.

### SUMMARY OF INVENTION

The purpose of this invention in light of the above is to provide an approach to display international and internal days or events, and this is done by synchronizing with the Hijri (AH) and Gregorian (AD) calendars to display all international days and events, such as Friendship Day, International Reading Day, New Year's Day, etc.

It also displays the internal events of each country, when allocating and specifying the country in which the National Day or other national events are displayed.

According to one embodiment of the invention, this objective is achieved by the present invention which is a method and device for displaying time and date in the form of a wall clock with many features in one clock.

During the year it may coincide with an important day such as someone's birthday, the New Year, the wedding anniversary, and any important international days, such as Mother's Day, World Health Day and other beautiful occasions, but we may forget the date of these days.

The invention of this clock that contains a smart electronic calendar and provides information at the right time in a seamless experience to get alerts and important information that the user needs on a daily basis.

There is also an application with the clock in which the ability to choose the international or internal option icon or both, with the customization of the country to synchronize the date of the important days in the calendar, and it supports all these features and contains several languages.

The main constituent feature of the invention is the possibility of specifying any date and naming the event (the date is chosen as a reminder). This new feature works in the clock when you select a specific date on the calendar, for example; someone's birth date, to display it in the screen with his name, and when this day comes from 12 am, the name will appear on the small screen, as well as in the international and internal days or events.

In addition to several other security features in the clock which are: Thermal encapsulation of the clock as it a first-class protection method, there is an infrared high-precision sensor in the clock to measure the temperature, a color display screen with large digits to read the temperature resulting, with goggles to protect the eye this goggles come with a thread attached to it.

The clock has a movement detector to detect the movement near it; the device is often integrated into a system that automatically performs a task or alerts about the user movement in the area.

There is a gas and smoke sensor MQ-2, and slots that emit ultrasound to repel rodents and insects through their direct impact on the nervous system of the insects without any harm to human health, a humane way to chase animals safe for children, pets and the environment.

The advantages of the invention are in the following points:
The clock contains several distinctive and comprehensive functions in just one clock.
The clock can be used anywhere at home, hospitals, companies, factories and schools, etc.
The clock can be used to tell the time in addition to the feature of reminding for all the important days and events.
The clock is not limited to an interface to show the time and date only, while it has a forehead temperature sensor (infrared), which is usually comes as a separate device, but in this invention it's connected with the clock, as well as the sensor for detecting smoke and flammable gases, in addition to a slots to emit ultrasound that repellent insects etc, all these sensors work as a separate effective devices, but in this invention all these important and safe features in this innovative clock and they work as one comprehensive device for all the required features.
The presence of a motion sensor feature that works through the laser light feature, when the motion is sensed near the device the light falls on the ground, thus the person stands on it and the temperature is measured without touching the device, this feature is not available in forehead temperature measurement devices.
The device contains protective eye glasses (goggles) for the eyes protection when standing and looking at the clock for precaution and safety it's an additional piece it could be or not, this glasses comes with a thread attached to it and a suitable hook to hang the glasses, this innovative method of attaching the glasses with the thread, so that the glasses were not mentioned as a separate additional piece comes with the device, it's connected to the thread because they might be lost, and the presence of the thread spool so that the length or shortness of the thread that coming out of the spool and connected to the glasses and hanging from the spool will be at the desired and appropriate length.
In the innovation of this thread that is connected to the glasses the most important characteristic of it, that it's strong and easy to cut for any weight more than 3 kg for safety and to reduce some accidents of suffocation with the thread which often occur to children.
All materials used in the manufacture of this clock are safe, not flammable, not harm to the human health, safe for children, pets and the environment.

### BRIEF DESCRIPTION OF THE DRAWINGS

In the following detailed portion of the present description, the teachings of the present application will be explained in more detail with reference to the example embodiment drawings which are briefly described as follows:

FIG. 1 Is the clock from the front shows the digital display screen, the infrared, the measurement result display screen, the small screen in which the reminder appears for the selected date, the thread spool, the goggles with the hook and underneath the clock is the laser light slots.

FIG. 2 Is the clock from the back and it shows the sound slots, the smoke and gas detector and the ultrasound slots.

### DETAILED DESCRIPTION OF INVENTION

Accordingly, the purpose of the current invention is to provide an improved wall clock that contains a smart Hijri (AH) and Gregorian (AD) electronic calendar wherein there is a list of all international and internal days or events for each country via a microcontroller therefore these days marked with the clock programming, the screen displays the current time applied to this time zone, another objective of the present invention is the presence of the sensors using Nanotechnology (Nano Sensors), these sensors include: a forehead thermometer (infrared), sensors for detecting toxic gases and smoke, in addition to the ultrasound slots that repel insects, etc.

*the Technical Features of the Clock*

It contains a counter for counting and storing time and date in different time zones, a processor to detect the operation mode of the selector switch, and a processor responding screen to display the time and date for the area code information in the code memory.

A device for calculating and storing the time and the date for each zone, the actual date is entered in the preferred form or the data set corresponding to the clock via the electromechanical interface, then the clock continues to work and displays the real time correctly.

This is achieved by using a program stored in a memory or by using the necessary data to correctly display the time also stored in a memory in preferred embodiments, therefore to optionally display the correct date such as the calendar data stored in the memory of the control circuit or microcontroller.

The data includes an “eternal” calendar in a leap year, reset from summer time to winter time and vice versa, especially in countries with multiple time zones, it's possible for the user to select the desired time zone via input to the control circuit or the microcontroller.

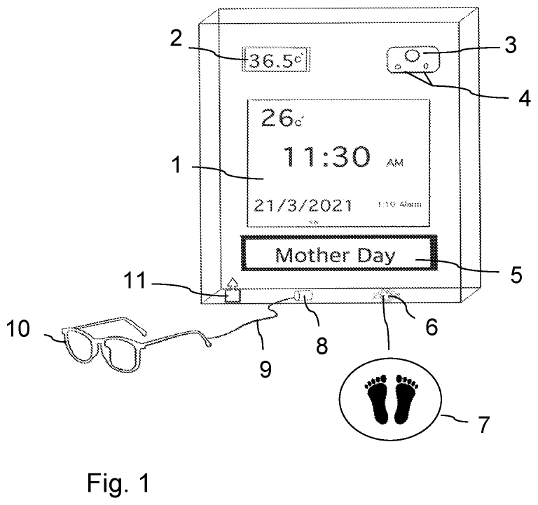

The digital display screen as shown in FIG. 1 Arrow (1), which is a light emission (LCD) screen. The screen contains digital numbers to represent the time; the clock supports the ability to get instant updates about the weather, sunrise and sunset times, in addition to its support to display prayer alerts, the date, the temperature and alarm.

The application supports several languages and runs on Android—IOS, it's will be provided in Google play/App Store.

Required System: Android 5.1 and latest version, IOS 8.0 and latest version.

Used Applications: Android and IOS.

In the programming of the clock and its application there is a database in Hijri (AH) and Gregorian (AD) calendar, thereby all international and internal days or events are marked according to the specified date then it will appear on the screen automatically as shown in FIG. 1 Arrow (5), thereby the event name will appears if the date for this day comes, and the same applies to the internal days and events in each country.

The clock connects to the phone using the Bluetooth LE Low Energy version which conserves energy and pushes information only when necessary.

The Power Source: The battery used in this clock is a rechargeable lithium-ion battery, which is a type of permanent secondary battery, it's recharged by absorbing light through the clock dial, and the charging is done by converting the fallen light into electrical energy. The permanent secondary battery does not require periodic replacement so at the end of its life it needs to be replaced with another secondary battery and not a different one such as regular silver oxide or others.

The power supply connected to the microcontroller to operate the clock; This power supply which contains battery to provide continuous power so that the function of the microcontroller and time base generator is guaranteed during the clock transfer using the time reference of the time base generator to update the time during the transmission of the clock, when the power supply is connected to the power, the microcontroller helps to make the clock displaying the current time in a specific geographical area.

When the power source is disconnected, the backup power supply ensures that the data stored in the memory is maintained, the microcontroller and time base generator are operational.

The power supply with a backup battery is adapted to ensure the function of the microcontroller and the time base generator during the movement of the clock to indicate the current time.

The external protection of the device is by thermal encapsulation of the clock as it is a first-class protection method, and it covers the device from all sides whether front or back, which provides maximum protection from the damage that the clock may be exposed to in case of fall, in addition to the protection from dust, dirt and stains or other factors that make the device looks unclean, it's also lasts for a long period of time without damage.

Programming the clock via the smart phone through the application, therefore there is no need to take down the clock for reprogramming or change the settings, because of the effort and riskiness of breaking it if the person falls trying to get the clock off the wall or return it back to the wall and the difficulty of doing that if the person is disabled, elderly or people with special needs, etc.

The clock supports the IP68 water resistance standard, which states that it's waterproof up to 5 meters deep and for 30 minutes, also it's resistant to dust, sweat, perfumes and cosmetics. All the materials that go into manufacture the clock are safe and not flammable.

The clock installation method: it will be done by fixing it to the wall using a hook or double-sided tape x1, this installation method on the wall is used instead of the traditional manual type, it's more effort-saving and comfortable in the installation.

*The Explanation of how the Reminder Feature is Done of the International Days and Events or any Other Marked Date*

This new function in the clock when specifying a particular date in the calendar for example; someone's birthday when this day comes from 12 am, his name will appear on the small screen, that's because it's been written and marked already on the calendar with the name, therefore this small screen will display all the marked date notifications as well as the matter in the international days and events, for example The International Mother's Day as shown in FIG. 1 Arrow (5).

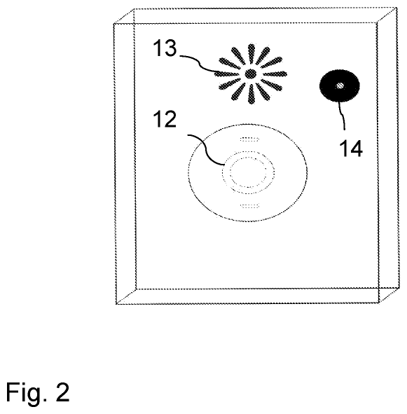

The name will be visible throughout the day, with a beep sound every 4 hours through the sound slots as shown in FIG. 2 Arrow (13), until the sound is turned off automatically by the application in the phone or manually from the clock, the same is done with the important international days or occasions in the year, once the date comes it will automatically appears in the screen directly with the event name, even if there is more than one date notification the screen will display each marked date alternately.

The alarm with this reminder begins four days before the date of any marked day, and the name will appear on the screen intermittently during these days, therefore when the date of this day comes, the name will appear on the screen throughout the day for 24 hours and the sound tone in every 4 hours until it's manually stopped from the clock or the application.

In the microprocessor and controller unit of the clock every date and special event whether international or internal specific to each country is marked and named to be displayed on the screen when the date of this day comes.

The clock relies on syncing with the Android and IOS Smartphone and displaying necessary notifications such as the notifying for an important meeting, date, or other alerts and information.

According to the present invention after manufactured the clock and before the user purchases it, the actual time is entered into it via an electromechanical interface, in the preferred form for the actual date or corresponding data set.

Then the clock continues to run and displays the actual time correctly, this is accomplished by using a program stored in memory or by using the necessary data to correctly display the time also stored in the memory in preferred embodiments, so it displays the information of the time and the date.

Especially in countries with multiple time zones, it is possible for the user to select the desired time zone via an input to a control circuit or a microcontroller.

The screen displays the current time applied to that time zone, and optionally the current date.

Store all calendar data including the “eternal calendar” leap years, and switch the time between summer/winter and vice versa in the memory as a primary data set for example; in (read-only memory or a memory with features or ROM features).

Via the electromechanical interface, it is recommended that the clock will be set to the current time and date for the concerned sales area. The data is digitally read via setup means, such as a mobile application with matching setup program into the memory and stored it there, starting from the data set across the interface then via the signal generated by the time base, in geographic regions or countries with multiple time zones setting is implemented for a specific time zone (base time zone).

The clock user chooses his time zone by entering the time that corresponds to the specific time zone in which it's located. From the data of the base time zone the microcontroller determines the data of the time zone specified by the user and stores it in the memory as the basis for further representation of the time and date on the screen by means of the electromechanical interface when the clock is initially set.

*The Security Sensors in the Clock*

The clock has a high-precision sensor to measure forehead temperature automatically without touch, which works in infrared as shown in FIG. 1 Arrow (3), with a color display screen in large digits numbers to comfortably read the resulting temperature as shown in FIG. 1 Arrow (2)

Where the internal temperature is measured without touching the person from a safe distance via the distance measuring sensor as shown in FIG. 1 Arrow (4) using an infrared technology that simply collects the temperature from the thermal radiation and the infrared energy released by the person.

All the mentioned measurements are for example, they may be change in the practical model (prototype) and the final manufacture.

The Infrared Device Contains:
The camera: 200 watt pixels it has a facial recognition technology without the other body parts, as in some smart mobile phones.
CPU: RK3288RAM2 GB
Material: ABS
Accuracy: 0.1° C. (0.1° F.)
Response time: 0.5 S
Measuring distance: 5-10 cm (3.9-2 inch)
Measuring temperature: 32° C.-42° C. (90° F.-104° F.)

Alarm Function:
32° C.<T<37.4° C. (green light)
37.4° C.≤T<38.5° C. (orange light and alarm)
38.5° C.≤T≤42° C. (red light and alarm)

In the above alarm function there is a smart alert feature with 3 colors depending on the situation:
Temperature higher than 32° C. and less than 37.4° C. (green light).
Temperature higher than 37.4° C. and less than 38.5° C. (orange light with alarm).
Temperature higher than 38.5° C. and less than 42° C. (red light with alarm) in addition to the multilingual audio broadcasting feature.

The clock has a movement detector to detect the movement near it; the device is often integrated into a system that automatically performs a task or alerts about the user movement in the area.

It only senses the falling of the moving object via emission or reflection.

Changes in proximity to the device are explained by electronics based on one of several technologies.

The technology used in this present invention is passive infrared (PIR), these sensors are sensitive to the temperature of the person's skin through black-body radiation emitted at medium infrared wavelengths.

These devices can detect objects, people or animals by capturing the infrared.

After sensing the movement near the clock, it automatically emits a green laser light on the ground from the slot as shown in FIG. 1 Arrow (6), which is a slot with a fixed template drawn on it a circle with a feet drawing shape inside it, this is in the programming of the clock so that the light falls into the ground in the form of feet shape as shown in FIG. 1 Arrow (7), for a person to stand on it and to be in an appropriate angle to the clock, and therefore it recognizes the face and measures the temperature, another person can come and do the same thereby it will recognize him.

The light slots as shown in FIG. 1 Arrow (6) consists from a laser medium, a power source (pumping source), two or more mirrors that constitute the transponder and direct the laser to a block of phosphorous, then the phosphorus radiates the light to ignite the light as in laser flashlight (pointer or laser pen).

Laser Output: <1 mW.

Laser Wavelength: about 650 nm

Plus an additional feature using the lasers, is the optical beams that emanate the light from the slots as shown in FIG. 1 Arrow (6) to organize the dimensions between any group in the same way but the difference at the same moment, the light will fall in the ground in the form of a regular points to organize and save distances between individuals using the same function by emits laser light to maintain social distancing while taking into account public health.

The glasses (goggles) to protect the eyes as shown in FIG. 1 Arrow (10) it comes with the device as an additional piece for the eyes protection when standing and looking at the clock, for safety and precaution this (goggles) comes with a thread attached to it as shown in FIG. 1 Arrow (9).

The Thread Specification:
Color: black
Diameter: 1 mm
Material: Made of flexible plastic rubber, strong and stretchable it's covered with fabric, it's strong but easy to cut for any weight more than 3 kilograms for safety and to reduce some of the asphyxiation incidents with the thread that often occur to the children.

The length of the thread is controlled by the bobbin that contains the thread, which has a length of 20 meters as shown in FIG. 1 Arrow (8) and it contains a button it's indicated by pressing it to control the length or shortness of the thread that coming out of the pulley and connected to the glasses (goggles) thus it can be dangling from the pulley at the desired and appropriate length.

FIG. 1 Arrow (11) is the place to hang the glasses (goggles) after the finish of using them, this simple additional feature is for saving the glasses from being lost if they come as a separate piece, thus it's connected to the clock via a thread and there is a designated place for hanging it.

The clock also has a gas and smoke sensor MQ-2 as shown in FIG. 2 Arrow (12). The gas sensor MQ2 analog unit uses smoke/LPG/CO MQ- and it triggers an alarm when it's sensitive to flammable gases or smoke, the operating voltage is +5V.

It can be used to measure or detect LPG, alcohol, propane, hydrogen, carbon monoxide and even methane, it can be used as a digital or analog sensor and the sensitivity of the digital pin can be changed with the potentiometer.

The MQ-2 LPG Butane Hydrogen Gas Sensor Detection Unit is useful for detecting; it is suitable for detecting H2, LPG, CH4, CO, alcohol, smoke or propane.

Due to its high sensitivity and fast response time, the measurement can be done instantly.

The sensitivity of the sensor can be adjusted with the potentiometer.

The MQ-2 gas sensor using gas-sensitive materials, the pure air in low conductivity of tin oxide (SnO2) with the sensor and when the existence of the flammable gases in the environment wherein the conductivity of the sensor increases with the concentration of the flammable gas increased in the air.

The clock has slots that emit ultrasound as shown in FIG. 2 Arrow (14) and it does not affect the human health or pets in the house, it does not emit any smells or sounds, it works to repel rodents and insects through its direct effect on the nervous system of insects without harm to human health, it's a humane way to chase animals, safe for children, pets and the environment.

It's also works to repel other insects such as cockroaches, wall geckos, spiders, ants and other crawling insects, mice, rats, dogs and foxes, etc.

The PIR motion sensor sensitively detects moving objects during operation.

Detection Range: Up to 26 feet, depending on the animal size (larger size-larger range).

This ultrasound works to scare the animals as the wave is activated when an animal enters the PIR sensor range, then the animals feel uncomfortable and will escape away from the area.

Frequency: 24 kHz (low frequency)-64 kHz (high frequency)

Power: 6 watts

The use of nanotechnology in these sensors (Nanotechnology Sensors) It makes the invention small in its size and technically powerful.

This clock may be simple in its shape, but it is specially prepared to work in harsh weather conditions and withstand humidity, high temperatures and extreme cold, it has several distinct and comprehensive features in one clock.

*There are many other technologies that exist in wall clocks systems, therefore those with traditional skills in the field will recognize that there might be other steps to implement the current invention, the current disclosure of all changes and modifications of these elements and methods are known by the specialists in the specific competence field of the invention.

This description is intended to clarify the invention rather than restrict it, which is defined by the attached claim elements.

1. A device comprising a global wall clock in its simple shape and the comprehensive functions.

2. According to claim 1, the clock contains a smart electronic calendar with a list of all international and internal days and events when specifying the country in which the National Day or other national events are to be displayed, this is done through the designed and developed programming in the clock system in addition to the system in the dedicated application in the smart phone.

3. A device according to claim 1, The clock has a prompt high-precision sensor (infrared) to measure the forehead temperature automatically without touching, that simply collects the temperature from the thermal radiation and the infrared energy released by the person, and the color display screen is with large digits to comfortably read the resulting temperature.

4. A device according to claim 1, the clock contains a motion detector the device is often integrated as a component into the system that automatically performs a task or alerts about the user movement in the area.
The technique used in the present invention is negative infrared (PIR), these sensors are sensitive to the temperature of a person's skin through black-body radiation emitted at a medium infrared wavelength.
These devices can detect objects and people or animals by capturing the infrared after sensing the motion near the clock.

5. A device according to claim 1, from the slots the clock automatically emits a green prompt laser light that falls to the ground.
The light slots are formed from a laser medium as in laser hand lamps (pointer or pen laser).

6. A device according to claim 5, which is a slot with a fixed template drawn on it a circle with a feet drawing shape inside it. This is in the programming of the clock so that the light falls into the ground in the form of feet shape, for a person to stand in it therefore to be in an appropriate angle to the clock, then the clock will recognize the face and measures the temperature.

7. A device according to claims 5 and 6, in addition to the light beams out of the slots in the programming it's also to organize the dimensions between any group in the same way but the difference at the same moment, the light will fall in the form of a regular points to organize and save distances between individuals using the same function by emits light and laser to maintain social distancing while taking into account public health.

8. A device according to claim 1, there is a glasses (goggles) to protect the eyes if the person wants to look at the clock when the function in claims 3-4-5-6-7 is on, this glasses comes with the device as an additional piece for safety and precaution.

9. A device according to claim 8, the glasses comes with a thread that is attached to it. It is made of flexible plastic rubber, strong and stretchy covered with fabric, it is strong but easy to cut for any weight more than 3 kilograms in order for safety to reduce some of the suffocation accidents with the thread that often occurs to children.

10. A device according to claim 9, the thread length is controlled via the bobbin that contains the thread, which has a length of 20 meters inside it, and it contains a button indicated by pressing it to control the length or shortness of the thread coming out of the pulley and connected to the glasses so that it is hanging in desired and appropriate length.

11. A device according to claim 8, there is a hook which is the place to hang the glasses after the finish of using them, this simple additional feature is for saving the glasses from being lost if they come as a separate piece, thus it's connected to the clock via a thread and there is a designated place for hanging it.

12. A device according to claim 1, the clock has a gas and smoke sensor MQ-2. It triggers an alarm when it is sensitive to flammable gases or sensitive to smoke, with operating voltage to detect H2, LPG, CH4, CO, alcohol, smoke or propane. Due to its high sensitivity and fast response time.

13. A device according to claim 1, the clock has slots that emit ultrasound it works to repel rodents and insects through its direct effect on the nervous system of insects a humane way to chase animals, safe for children pets and the environment, with wide detection range, different levels of frequency (low and high) and an appropriate power.
